(19) United States
(12) Patent Application Publication
(10) Pub. No.: US 2015/0134134 A1
(43) Pub. Date: May 14, 2015

(54) BRIDGE-INTELLIGENT ELECTRONIC DEVICE OF ROUTING MESSAGES BETWEEN SUB-NETWORKS

(71) Applicant: ABB TECHNOLOGY AG, Zurich (CH)

(72) Inventor: Horst Büker, Minden (DE)

(73) Assignee: ABB TECHNOLOGY AG, Zurich (CH)

(21) Appl. No.: 14/598,845

(22) Filed: Jan. 16, 2015

Related U.S. Application Data
(63) Continuation of application No. PCT/EP2013/001766, filed on Jun. 14, 2013.

(30) Foreign Application Priority Data
Jul. 16, 2012 (EP) 12005218.8

(51) Int. Cl. H04L 12/18; G05F 1/66; G05B 15/02; H04W 4/06; H04L 12/10

(52) U.S. Cl. CPC H04L 12/1886; H04W 4/06; H04L 12/10; G05B 15/02; G05F 1/66; H04W 88/16
USPC 700/286; 370/312

(57) ABSTRACT

A Bridge-Intelligent Electronic Device (IED) is disclosed to route IEC61850 GOOSE messages between sub-networks (SN_{—}1, SN_{—}2 . . . SN_n), wherein the Bridge-Intelligent Electronic Device (IED) can include a component with functionality for signal mapping, and more than one communication interface (CI-1, CI-2 . . . CI-n), wherein each communication interface (CI-1, CI-2 . . . CI-n) is designed as an Intelligent Electronic Device (IED) with its own CID-(Configured IED Description) file according to an IEC 61850 requirement.

### RELATED APPLICATION

This application claims priority as a continuation application under 35 U.S.C. §120 to PCT/EP2013/001766, which was filed as an International Application on Jun. 14, 2013 designating the U.S., and which claims priority to European Application 12005218.8 filed in Europe on Jul. 16, 2012. The entire contents of these applications are hereby incorporated by reference in their entireties.

### FIELD

The present disclosure relates to a Bridge-IED (Intelligent Electronic Device) to route IEC61850 GOOSE messages between sub-networks (e.g., in power generation facilities or in electric power transformation substations). Furthermore this disclosure relates to a sub-network system (e.g., in power generation facilities or in electric power transformation substations), wherein each sub-network contains a plurality of Bridge-IED's.

### BACKGROUND INFORMATION

IEC 61850 is an Ethernet-based international standard for communication in power generation facilities and electric power transformation substations to integrate all of the protection, control, measurement and monitoring functions within a substation or a sub-network and to provide Intelligent Electronic Devices for the high-speed substation protection applications, interlocking and intertripping.

The term or mechanism GOOSE (Generic Object Oriented Substation Events) describes a control model mechanism in which any format of data (e.g., status, value), are grouped into a data set, transmitted within a short time period and used to ensure specified transmission speed and reliability.

GOOSE data is directly embedded into Ethernet data packets and works on publisher-subscriber mechanism on multicast or broadcast addresses. The GOOSE communication is specified in the IEC 61850 Standard by the International Electrotechnical Commission (IEC).

The IEC61850 GOOSE is an advanced version of the UCA GOOSE. A GOOSE message is used to exchange data between IED's. GOOSE is a mechanism for fast transmission of substation events, such as commands and alarms. A single GOOSE message sent by an IED can be received and used by several receivers. In a common sub-network one device, the sender publishes information, while only the subscriber devices are receiving it. The reaction of each receiver depends on its configuration and functionality.

Furthermore GOOSE is designed as Publisher-Subscriber model and the publisher IED transmit as multicast to all connected subscriber IEDs. Generally, all IEDs that communicate via GOOSE messages have to be combined in one sub-network. The sub-network could be a physical sub-network or via VLAN (virtual LAN) configuration in a logical sub-network, so that specified (e.g., important) signals (e.g., protection signals) can only be transferred between IEDs in the same sub-network.

In the IEC 61850 specification a GOOSE protocol is scheduled for data exchange among IEDs, also being called horizontal communication or horizontal fast IED-IED communication and is generally based on peer-to-peer communication.

### SUMMARY

A bridge-IED (Intelligent Electronic Device) is disclosed for routing IEC (International Electro-technical Commission) 61850 GOOSE (Generic Object Oriented Substation Event) messages between sub-networks (SN_1, SN_2 . . . SN_n), wherein the Bridge-IED comprises: a mobile component with functionality for signal mapping; and plural communication interfaces (CI-1, CI-2 . . . CI-n), wherein each said communication interface (CI-1, CI-2 . . . CI-n) is configured as an IED with its own CID (Configured IED Description) file according to an IEC 61850 requirement.

### BRIEF DESCRIPTION OF THE DRAWINGS

Features and advantages of the present disclosure, as well as advantageous refinements and improvements of already discussed embodiments, will be described and explained in more detail using the exemplary embodiments illustrated in the following drawings, in which:

FIG. 1 shows an exemplary new Bridge-IED with communication interfaces for each connected sub-network; and

FIG. 2 shows an exemplary Bridge-IED in an exemplary redundant embodiment for a communication board and/or for backbone electronics.

### DETAILED DESCRIPTION

Known substation IED's have only one Ethernet interface with a communication protocol specified in IEC 61851 Edition1, and for the new defined redundancy requirement in IEC 61850 Edition2, a second Ethernet interface with switch functionality inside the IED (HSR or DRP).

GOOSE messages are not routable between several sub-networks (e.g., in power generation facilities or in electric power transformation substations). But protection signals or binary signals and analog values are sent via a GOOSE protocol which is not only used between IED's configured in one SCD (Substation Configuration Description) file in a given sub-network configuration. A SCD-file is a file describing the substation configuration and communication details. Often it is desired or required, to send such signals to other sub-networks to react on these signals, such as for a load shedding application to protect a shutdown of the plant.

A new solution is disclosed to route IEC 61850 GOOSE messages between several sub-networks (e.g., in power generation facilities or in electric power transformation substations) by using an IED-Bridge.

The newly disclosed Bridge-IED can, for example, include a base functionality for signal mapping and an additional modular number of communication interfaces each designed as an IED with its own configurable CID-file according to an IEC 61850 requirement, wherein the CID-file can contain information from a configuration tool to a substation regarding one specific IED at the substation.

According to an exemplary embodiment, it is provided that each sub-network is engineered separately with the IEC 61850 engineering tool and the result of this Engineering process is exported in the respective SCD-file.

An exemplary communication interface IED of the Bridge-IED is described with an IEC 61850 CID-file and is configured in the IED description.

In another exemplary aspect, a Bridge-IED itself can have application software, that allows free filtering and/or mapping of received signals and can rearrange the signals to new data telegrams that are published and transferred free from each connected communication interface to the connected sub-networks.

Exemplary embodiments of a new Bridge-IED as disclosed herein can allow routing of route GOOSE signals between different sub-networks.

According to exemplary embodiments, proposed solutions can be handled and configured as a standard IED according IEC 61850 for GOOSE communication.

Additionally, exemplary embodiments can be configured for filtering or rearranging received and transmitted signals.

According to an exemplary embodiment, a flexible signal configuration can be configured by using signal matrix or mapping functionality.

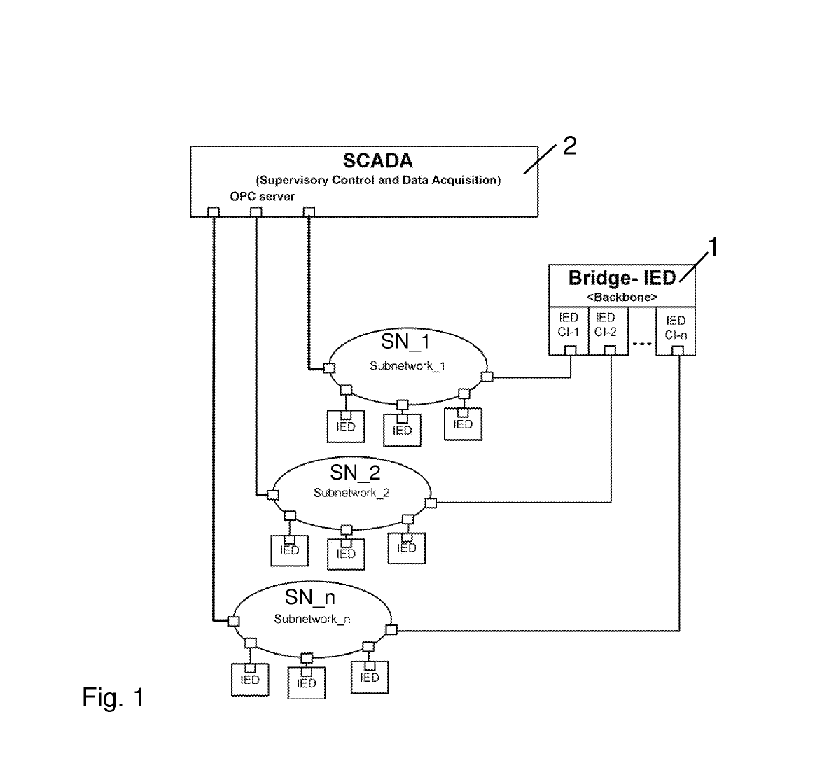

FIG. 1 shows an example of a newly disclosed Bridge-IED 1 with communication interfaces CI-1, CI-2 . . . CI-n for each connected sub-network

SN_1, SN_2 . . . SN_n in a Supervisory Control and Data Acquisition SCADA by using an OPC Server 2. The exemplary Bridge-IED 1 can be implemented in a communication board and/or in backbone electronics.

Each sub-network SN_1, SN_2 . . . SN_n contains a plurality of IED's and can be connected with the OPC-Server 2 of the SCADA system. IED's are intelligent electronic devices, such as automation components for substation automations; for example, like controllers in a distributed control system (DCS).

The Bridge-IED 1 can be a component with a base functionality for signal mapping and an additional number of modular communication interfaces CI-1, CI-2 . . . CI-n each designed as an IED with its own configurable CID-file according to an IEC 61850 requirement.

According to an exemplary embodiment, each sub-network SN_1, SN_2 . . . SN_n is engineered separately with an IEC 61850 engineering tool and the result is exported in a SCD-file. The communication interfaces IED CI-1, CI-2 . . . CI-n from the Bridge-IED 1 are described with a normal IEC 61850 CID-file (configured IED description) and can be handled and configured as a standard IED according to an IEC 61850 for GOOSE communication.

The Bridge-IED 1 itself can have an application software that allows free filtering and/or mapping of received signals and rearranging of the signals to new data telegrams that can be published and transferred free from each connected communication interface CI-1, CI-2 . . . CI-n to the connected sub-networks SN_1, SN_2 . . . SN_n.

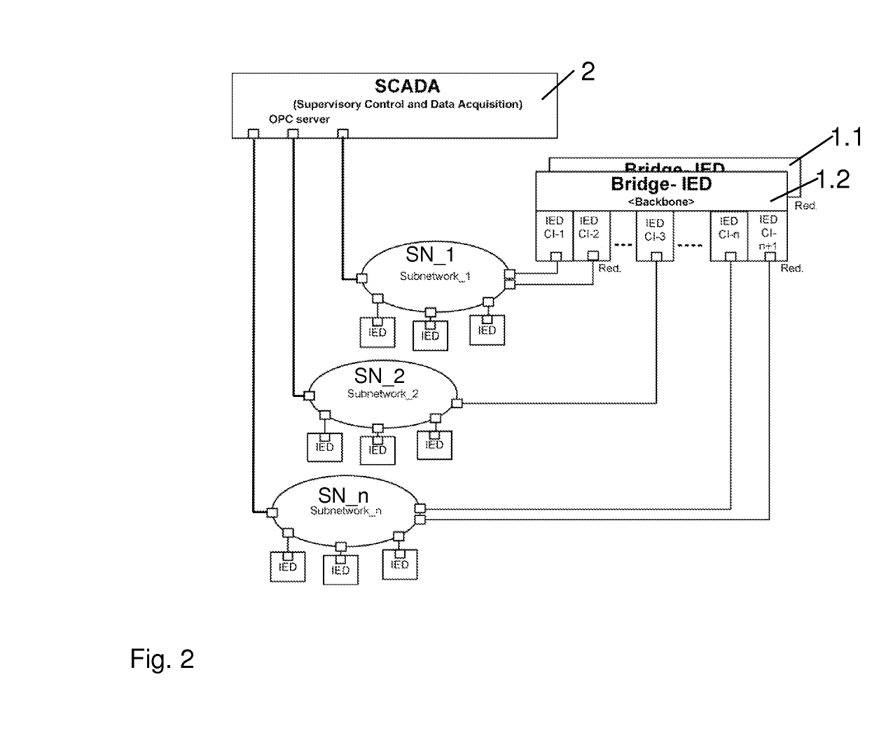

FIG. 2 shows exemplary Bridge-IED's 1.1, 1.2 in an exemplary redundant embodiment for communication board and/or for backbone electronics.

Also the communication interfaces IED CI-1, CI-2, CI-3 . . . CI-n, CI-n+1 can be redundant for each sub-network SN_1, SN_2 . . . SN_n.

According to the exemplary embodiment shown in FIG. 2, for higher availability the Bridge-IED can be used in a redundant manner such as:
redundant communication interface CI-1, CI-2, CI-3 . . . CI-n, CI-n+1, in which two communication interfaces (e.g. CI-1 and CI-2) are configured in the same sub-network as publisher and/or subscriber;
redundant Bridge-IED backbone, in which the backbone electronic device parts 1.1, 1.2 are set redundant.

The disclosed Bridge-IED can have more than one IEC 61850 communication interface and each of them can be engineered in different sub-networks with separate SCD-files. As a result the new Bridge-IED can allow such a routing functionality inside the IED. Additionally Ethernet network switches can provide such functionality.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A bridge-IED (Intelligent Electronic Device) for routing IEC (International Electro-technical Commission) 61850 GOOSE (Generic Object Oriented Sub-station Event) messages between sub-networks (SN_1, SN_2 . . . SN_n), wherein the Bridge-IED comprises:
a mobile component with functionality for signal mapping; and
plural communication interfaces (CI-1, CI-2 . . . CI-n), wherein each said communication interface (CI-1, CI-2 . . . CI-n) is configured as an IED with its own CID (Configured IED Description) file according to an IEC 61850 requirement.

2. The bridge-IED according to claim 1, wherein each sub-network (SN_1, SN_2 . . . SN_n) comprises:
a respective SCD-file engineered separately with an IEC 61850 engineering tool.

3. The bridge-IED according to claim 1, wherein the each communication interfaces (CI-1, CI-2 . . . CI-n) of the Bridge-IED is described by an IEC 61850 CID-file and is configured in an IED description.

4. The bridge-IED according to claim 1, comprising:
application software for free filtering and/or mapping of received signals and/or for rearranging the signals to new data telegrams, the application software being published and freely transferred from each connected communication interface (CI-1, CI-2 . . . CI-n) to the connected sub-networks (SN_1, SN_2 . . . SN_n).

5. The bridge-IED according to claim 1, configured as a standard IED according to an IEC 61850 for GOOSE communication.

6. The bridge-IED according to claim 1, comprising:
communication interfaces (CI-1, CI-2, CI-3 . . . CI-n, CI-n+1) which are redundant for each sub-network (SN_1, SN_2 . . . SN_n).

7. The bridge-IED according to claim 6, comprising:
redundant communication interfaces (CI-1, CI-2, CI-3 . . . CI-n, CI-n+1) in which two communication interfaces IED are configured in a same sub-network as publisher and/or subscriber.

8. A sub-network system configured for a power generation facility or an electric power transformation substation, wherein each sub-network (SN_1, SN_2 . . . SN_n) comprises:
a plurality of Bridge-IED's, each Bridge-IED configured according to claim 1, and connected with an OPC-Server of a SCADA (Supervisory Control And Data Acquisition) system.

9. The bridge-IED according to claim 2, wherein the each communication interfaces (CI-1, CI-2 . . . CI-n) of the Bridge-IED is described by an IEC 61850 CID-file and is configured in an IED description.

10. The bridge-IED according to claim 9, comprising:
application software for free filtering and/or mapping of received signals and/or for rearranging the signals to new data telegrams, the application software being published and freely transferred from each connected communication interface (CI-1, CI-2 . . . CI-n) to the connected sub-networks (SN_1, SN_2 . . . SN_n).

11. The bridge-IED according to claim 10, configured as a standard IED according to an IEC 61850 for GOOSE communication.

12. The bridge-IED according to claim 11, comprising:
communication interfaces (CI-1, CI-2, CI-3 . . . CI-n, CI-n+1) which are redundant for each sub-network (SN_1, SN_2 . . . SN_n).

13. The bridge-IED according to claim 12, comprising:
redundant communication interfaces (CI-1, CI-2, CI-3 . . . CI-n, CI-n+1) in which two communication interfaces IED are configured in a same sub-network as publisher and/or subscriber.

14. A sub-network system configured for a power generation facility or an electric power transformation substation, wherein each sub-network (SN_1, SN_2 . . . SN_n) comprises:
a plurality of Bridge-IED's, each Bridge-IED configured according to claim 13, and connected with an OPC-Server of a SCADA (Supervisory Control And Data Acquisition) system.
